(19) United States
(12) Patent Application Publication
(10) Pub. No.: US 2011/0276989 A1
(43) Pub. Date: Nov. 10, 2011

(54) OPTICAL PICKUP DEVICE AND OPTICAL DISC DRIVE

(75) Inventors: Yuichi TAKAHASHI, Nara (JP); Kazuo MOMOO, Osaka (JP); Hiroaki MATSUMIYA, Osaka (JP); Jun-ichi ASADA, Hyogo (JP)

(73) Assignee: PANASONIC CORPORATION, Osaka (JP)

(21) Appl. No.: 12/983,990

(22) Filed: Jan. 4, 2011

(30) Foreign Application Priority Data
Jan. 6, 2010 (JP) 2010-000962

(51) Int. Cl. G11B 7/135; G11B 19/20

(52) U.S. Cl. 720/695; 369/112.24; G9B/7.121; G9B/19.027

(57) ABSTRACT

Has an object of providing an optical pickup capable of realizing tracking control or focus control at a higher level of precision even when relative positions of a light source and a light detector are shifted due to a change in the environmental temperature, long-term deterioration or the like. The optical pickup includes a base member; a light source, fixed to the base member, for emitting a laser beam; an objective lens for collecting the laser beam onto an optical disc; a light detector, fixed to the base member, for detecting the laser beam reflected by the optical disc; fixing means for fixing the light source and/or the light detector to the base member; and a light blocking section for blocking a central portion of the laser beam in a circular shape on an optical path between the collimator lens and the light detector.

### BACKGROUND OF THE INVENTION

1. Field of the Invention

The present invention relates to an optical pickup device capable of reading information from an optical disc and an optical disc drive including such an optical pickup device.

2. Description of the Related Art

Currently, optical pickup devices capable of reading information from optical discs such as a BD (Blu-ray disc), a DVD (Digital Versatile Disc) and the like are provided.

Such an optical pickup device is, for example, as described in Japanese Laid-Open Patent Publication No. 2007-42230.

In the optical pickup device described in Japanese Laid-Open Patent Publication No. 2007-42230, focus control and tracking control can be performed in order to deal with surface fluctuation of an optical disc. Namely, in a conventional optical pickup device, light (laser beam) emitted from a light source (light emitting diode) is collected onto an optical disc by an objective lens. Then, in the optical pickup device, the light reflected by the optical disc is detected by a light detector. The optical pickup device drives the objective lens based on a signal of the light detected by the light detector. Thus, the optical pickup device can perform focus control and tracking control.

In the optical pickup device, the light source and the light detector are located on an optical base (member acting as a substrate) such that the light source and the center of the light detector (center of a light receiving element structured to have four areas) are positioned conjugate with respect to the optical system.

In the optical pickup device described above, the light source and/or the light detector needs to be fixed to the optical base with very highly precise positional alignment of a micrometer order and the fixed state needs to be retained. In the above optical pickup device, the light reflected by an optical disc is received by a light receiving section of about 100 μm square on the light detector. The light receiving section is divided into a plurality of areas, and the light source and the light detector are positionally aligned such that the beam to be detected is incident on a position over a dividing line. By performing various types of arithmetic operation on the amount of light incident on each of the areas, focus control or tracking control on the optical disc is performed. Therefore, if the beam to be detected is shifted even by several micrometers on the light receiving section, the light amount balance among the divided areas is changed and thus the quality of the control signal is deteriorated. In a worst case, the control becomes impossible. Henceforth, a high level of reliability is required for the fixed state after the positional alignment.

As a fixing method, laser welding or tightening with screws are conceivable. However, in order to meet the demands of simplification, cost reduction, size reduction and the like of the optical pickup device, a simpler structure is needed. Thus, fixation retaining means which has been used most commonly recently is use of an adhesive.

However, where the light source and/or light detector is fixed to the optical base with an adhesive, the following problems occur.

Due to a change in the environmental temperature and long-term deterioration, relative positions of the light source and the light detector may be shifted. For example, when the environmental temperature is raised, the adhesive fixed to the optical base is softened. Therefore, the position of the light source is shifted. Similarly, the position of the light detector fixed to the optical base is shifted.

In such a state, the light beam is not incident on a prescribed position of the light receiving section. Therefore, the precision of tracking control and focus control of the optical pickup device is lowered. Especially, the light (laser beam) emitted from the light source has a property that the intensity thereof has a Gauss distribution (the intensity of the center of the light beam is stronger than the intensity of the periphery of the light beam). Therefore, of the light incident on the light detector, a signal of a portion including the center and the vicinity thereof has a large influence on the optical signal. Namely, the shift of the relative positions of the light source and the light detector leads to the deterioration of servo performance.

This will be described in more detail. For example, it is assumed that as shown in FIG. 1, a laser beam is incident on a position shifted from the center of the light detector. A tracking error signal TE when this occurs can be found by the following expression (1). It is assumed that the light detector includes light receiving areas A through D.

TE=(A+B)−(C+D) (1)

In order to detect a shift of tracking of the laser beam with respect to the track of the optical disc, a signal of an X portion of the light incident on the light detector as shown in FIG. 1 needs to be detected. The reason for this is that the light diffracted at an edge of the track of the optical disc has a meaning as a signal for tracking control (as light for determining whether there is a shift of tracking or not as shown in FIG. 2). Namely, when there is a tracking shift with respect to the optical disc, the ratio in the X portion is changed. In this manner, the optical pickup device can perform tracking control.

However, because the laser beam has a strong intensity at the central portion thereof, the difference of the value of (C+D) with respect to the value of (A+B) is large regardless of the intensity of the light in the X portion. In such a state, highly precise tracking cannot be performed. FIG. 3 shows an example of signals obtained by the light detector when the light source is shifted from the center of the light detector and when the light source is not shifted from the center of the light detector. As shown in FIG. 3, when the light source is not shifted from the center of the light detector, the level of the signal TE is varied around 0. From this, it is understood that information in the portions other than the X portion has no specific problem. By contrast, when the source is shifted from the center of the light detector, the level of the signal TE is varied in an area away from 0. From this, it is understood that information in the portions other than the X portion influences the signal TE.

### SUMMARY OF THE INVENTION

The present invention, for solving the above-described problems, has an object of providing an optical pickup device capable of realizing tracking control or focus control at a higher level of precision even when the center of the light source and the center of the light detector are shifted from each other due to a change in the environmental temperature, long-term deterioration or the like.

An optical pickup device according to the present invention includes a base member; a light source, fixed to the base member, for emitting a laser beam; an objective lens for collecting the laser beam onto an optical disc; a light detector, fixed to the base member, for detecting the laser beam reflected by the optical disc; an adhesive for fixing the light source and/or the light detector to the base member; and a light blocking section for blocking a central portion of the laser beam in a circular shape on an optical path between the collimator lens and the light detector.

Owing to such a structure, the light detector section can reduce the influence of the light amount of the central portion of the light beam, and even where a relative position of the light source or the light detector is shifted, can suppress the TE signal or the FE signal from being offset.

Therefore, the optical pickup device, owing to the light detector, can suppress the quality of a signal necessary for tracking control or focus control, especially the sensitivity to the shift of a relative position of the light source or the light detector, from being deteriorated. Namely, highly reliable detection of a control signal is made possible.

### BRIEF DESCRIPTION OF THE DRAWINGS

FIG. 1 is a view illustrating problems of the conventional art.

FIG. 2 is a view illustrating problems of the conventional art.

FIG. 3 is a view illustrating problems of the conventional art.

FIG. 4 is a structural view illustrating an optical disc drive according to an embodiment of the present invention.

FIG. 5 shows a structure and light beams for illustrating an optical pickup device according to an embodiment of the present invention.

FIG. 6A is a view illustrating a structure of a waveplate according to an embodiment of the present invention.

FIG. 6B is a view illustrating a structure of the waveplate according to an embodiment of the present invention.

FIG. 7 is a view illustrating a light detector according to an embodiment of the present invention.

FIG. 8 is a view illustrating deterioration in the light collecting performance of an objective lens.

FIG. 9 shows a structure and light beams for illustrating an optical pickup device according to a modification of an embodiment of the present invention.

FIG. 10 is a view illustrating an example of effect provided by an embodiment of the present invention.

FIG. 11 is a view illustrating another example of effect provided by an embodiment of the present invention.

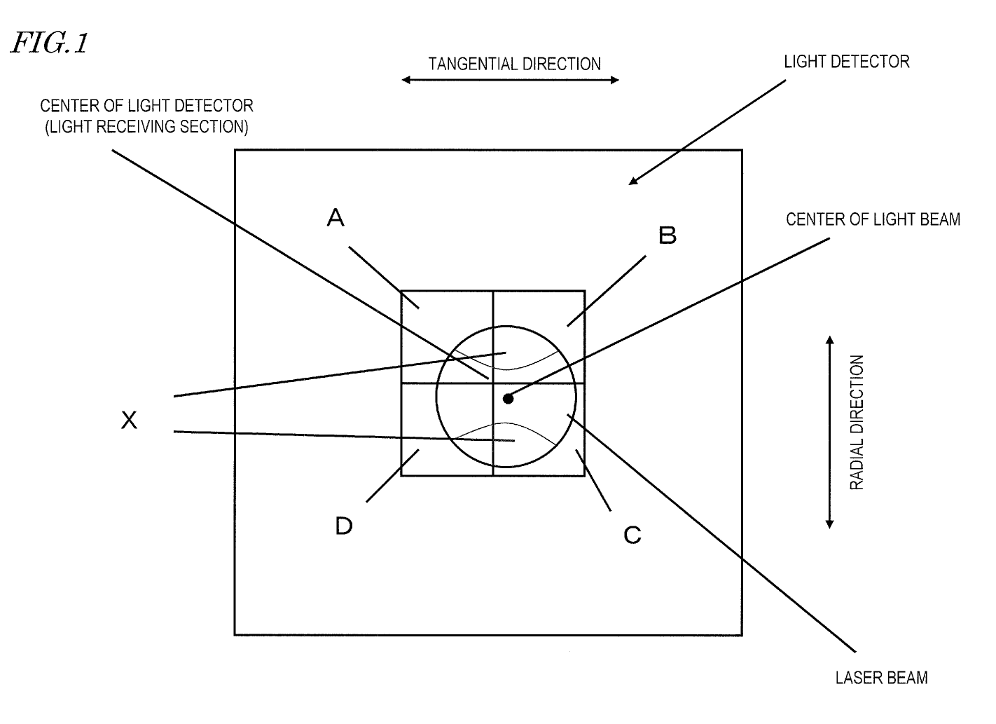

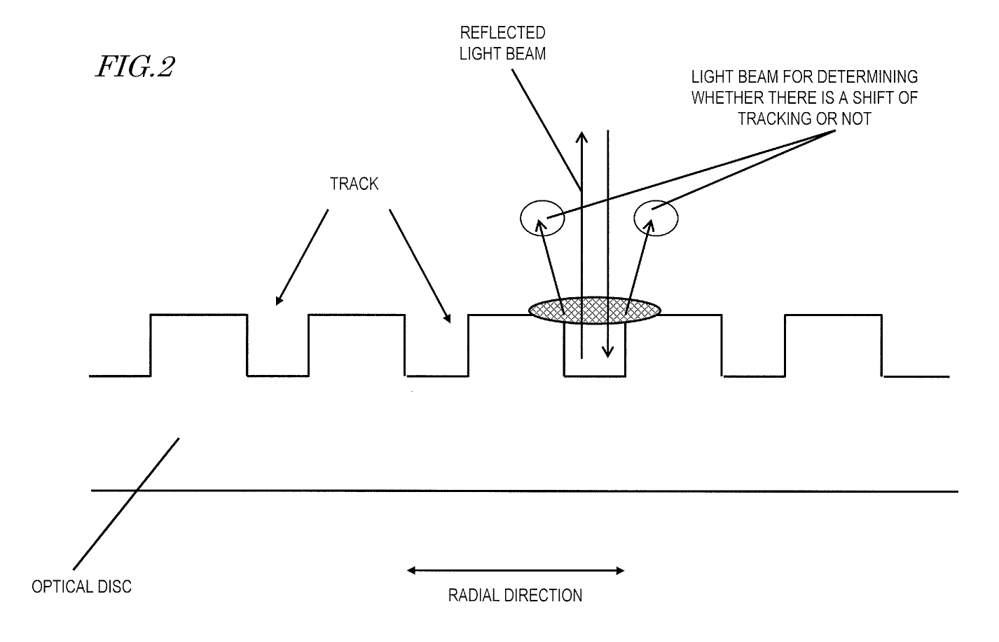

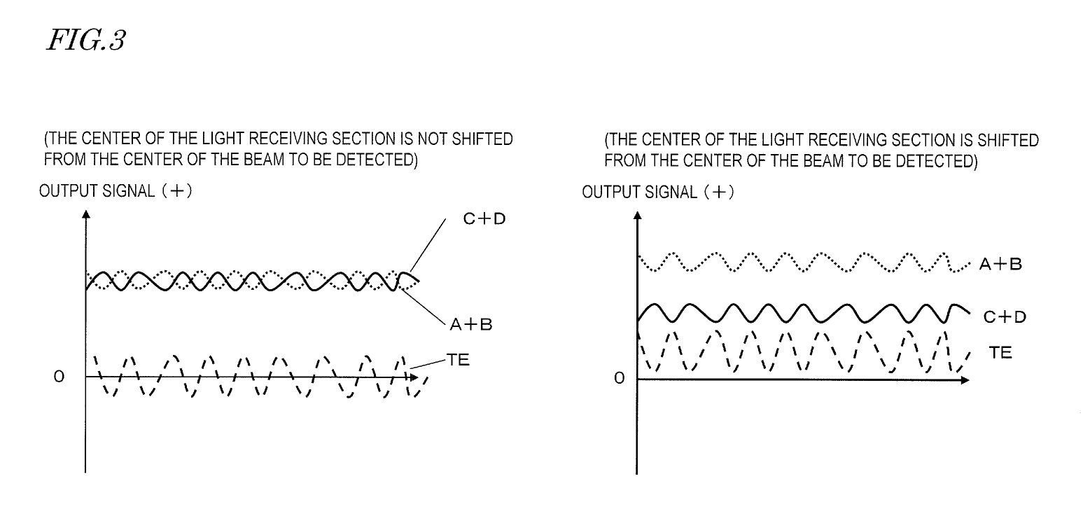

### DETAILED DESCRIPTION OF PREFERRED EMBODIMENTS

The present invention can be embodied as an optical pickup device and an optical disc drive including the optical pickup device. Hereinafter, a structure of the optical disc drive will be first described. Then, the optical pickup device mounted on the optical disc drive will be described.

An optical pickup device 100 according to an embodiment will be described. The optical pickup device 100 can read information from an optical disc when being mounted on an optical disc drive. Before describing a structure of the optical pickup device 100, a structure of the optical disc drive will be described.

### <1. Structure of the Optical Disc Drive>

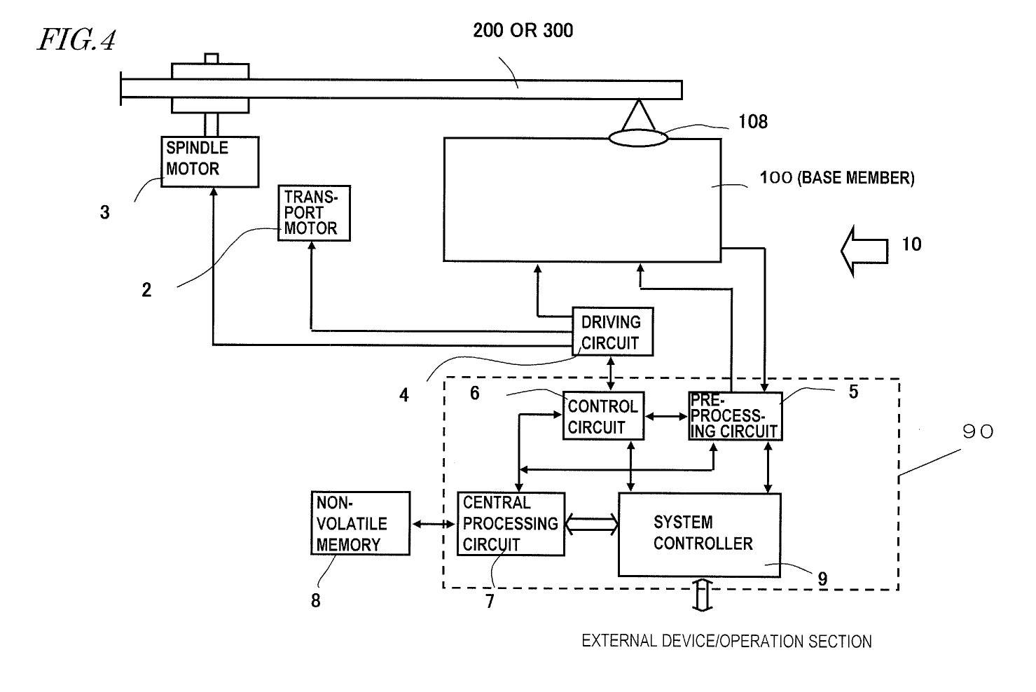

A structure of an optical disc drive 10 will be described with reference to FIG. 4. The optical disc drive 10 (hereinafter, referred to as the “drive 10”) is usable for a personal computer, an optical disc player, an optical disc recorder or the like.

FIG. 4 is a structural view of the drive 10. The drive 10 includes the optical pickup device 100, a transport motor 2, a spindle motor 3, a driving circuit 4, a nonvolatile memory 8, and a control section 90.

The transport motor 2 moves the optical pickup device 100 based on an instruction from the driving circuit 4.

The spindle motor 3 rotates the optical disc 200 or 300 based on an instruction from the driving circuit 4.

The driving circuit 4 controls an operation of a light source provided in the optical pickup device 100. The driving circuit 4 also controls driving amounts such as a distance by which the optical pickup device 100 is moved by the transport motor 4, a rotation rate of the spindle motor 3 and the like, based on instructions from the control section 90.

The nonvolatile memory 8 holds information necessary for controlling, for example, the optical pickup device 100.

The control section 90 controls an operation of the optical disc drive 10. The control section 90 includes a pre-processing circuit 5, a control circuit 6, a central processing circuit 7, and a system controller 9. The optical pickup device 100 is electrically connected to the pre-processing circuit 5 as signal processing means and to driving circuit 4 for controlling an operation of an objective lens 108, a light source 101 and a light source 102 of the optical pickup device 100. Thus, the optical pickup device 100 sends and receives an electric signal to, and from, the pre-processing circuit 5 and the driving circuit 4.

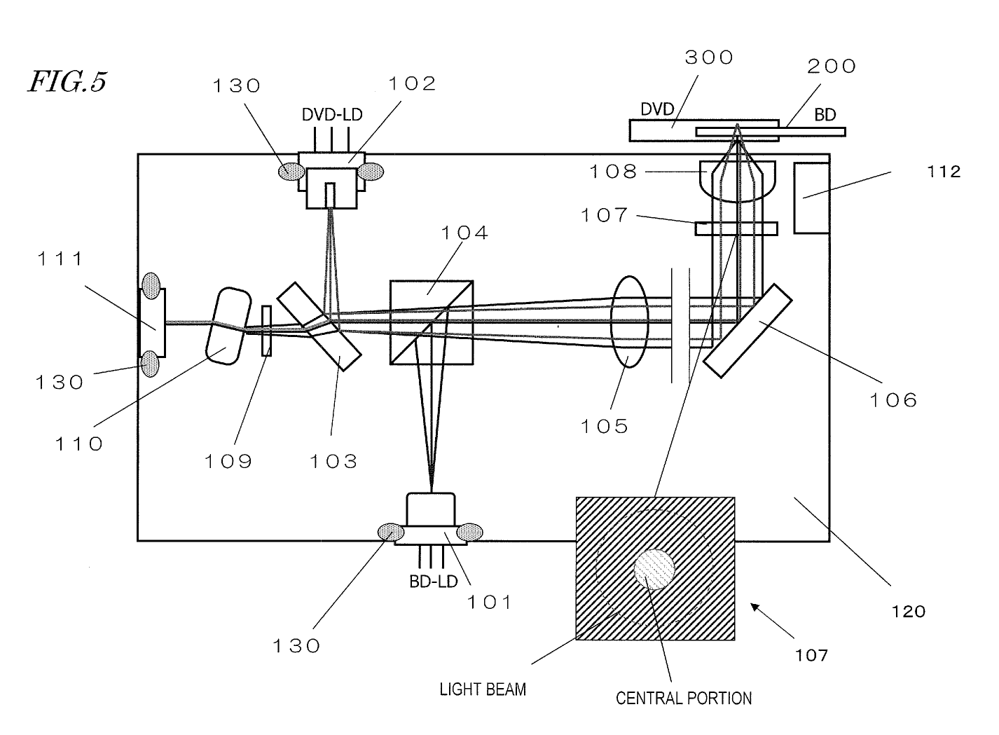

Data which is optically read from the optical disc 200 (300) is converted into an electric signal by a light detector 111 (FIG. 5) of the optical pickup device 100. This electric signal is input to the pre-processing circuit 5 via signal connection means not shown. The pre-processing circuit 5 generates servo signals including a focus error signal and a tracking error signal, and also performs waveform equalization of a reproduction signal, slicing of a signal into binary data, and processing of an analog signal such as a synchronous data or the like, based on an electric signal obtained from the optical pickup device 100.

A servo signal generated by the pre-processing circuit 5 is input to the control circuit 6. The control circuit 6 causes an optical spot of the optical pickup device 100 to follow the optical disc 200 (300) via the driving circuit 4. The driving circuit 4 is connected to the optical pickup device 100, the transport motor 2, and the spindle motor 3. The driving circuit 4 performs a series of controls including focus control and tracking control by the objective lens 108, transfer control, spindle motor control and the like by means of digital servo. The driving circuit 4 acts to appropriately drive an actuator coil 112 (coil, magnet or the like) on the objective lens 108, drive the transport motor 2 for moving the optical pickup device 100 to an inner part or to an outer part of the optical disc 200, and drive the spindle motor 3 for rotating the optical disc 200 (300).

The synchronous data generated by the pre-processing circuit 5 is subjected to digital signal processing by the system controller 9, and the resultant recording/reproduction data is forwarded to a host computer via an interface not shown. The pre-processing circuit 5, the control circuit 6 and the system controller 9 are connected to the central processing circuit 7, and are operated by an instruction from the central processing circuit 7. A program for defining a series of operations including the control operations described above is stored on a semiconductor device such as the nonvolatile memory 8 as firmware in advance. The control operations include an operation of rotating the optical disc 200 (300), an operation of moving the optical pickup device 100 to a target position, an operation of forming an optical spot on a target track of the optical disc 200 (300) and causing the optical spot to follow the track, and the like. Such firmware is read from the nonvolatile memory 8 by the central processing circuit 7 in accordance with the form of the necessary operation.

In this specification, the pre-processing circuit 5, the control circuit 6, the central processing circuit 7, the nonvolatile memory 8 and the system controller 9 will be collectively referred to as the “control section 90”. The pre-processing circuit 5, the control circuit 6, the central processing circuit 7, the nonvolatile memory 8 and the system controller 9 can be realized in the form of a semiconductor chip (IC chip). The driving circuit 4 can be realized in the form of a driver IC.

### <2. Structure of the Optical Pickup Device>

FIG. 5 shows a structure of the optical pickup device 100 and also shows a route of the light beam. FIG. 5 is a schematic view. In FIG. 5, a collimator lens 105 and a reflector plate 106 are located such that the polarization axes thereof are at 90 degrees to each other.

The optical pickup device 100 includes a semiconductor laser 101 for BD, a semiconductor laser 102 for DVD, a plate beam splitter 103, a cubic beam splitter 104, the collimator lens 105, the reflector plate 106, a waveplate 107, the objective lens 108, a hologram 109, a cylindrical lens 110, the light detector 111, and the actuator 112, which are provided on an optical base 120. The semiconductor laser 101 for BD, the semiconductor laser 102 for DVD, the light detector 111 and the like are fixed to the optical base 120 with an adhesive 130.

The semiconductor laser 101 for BD is formed of a semiconductor material and is capable of emitting a laser beam having an aligned phase and a wavelength of 405 nm. The semiconductor laser 102 for DVD is formed of a semiconductor material and is capable of emitting a laser beam having an aligned phase and a wavelength of 650 nm.

The plate beam splitter 103 is a plate-like beam splitter. The plate beam splitter 103 is structured so as to, when P polarization is incident thereon, transmit the light, and, when S polarization is incident thereon, reflect the light.

The cubic beam splitter 104 is a cube-shaped beam splitter. The cubic beam splitter 104 is structured so as to, when P polarization is incident thereon, transmit the light, and, when S polarization is incident thereon, reflect the light. The cubic beam splitter 104 is structured so as to transmit the laser beam from the direction of the plate beam splitter 103.

The collimator lens 105 is a lens for, when a laser beam is incident thereon from the semiconductor laser 101 for BD or the semiconductor laser 102 for DVD, converting the laser beam into collimated light. The collimator lens 105 is also a lens for, when the light reflected by the BD 200 or the DVD 300 is incident thereon, collecting the reflected light such that the reflected light is focused on the light detector 111.

The reflector plate 106 is a reflective plate for reflecting a light beam. The reflector plate 106 is structured so as to reflect light regardless of the polarization state.

The waveplate 107 is a waveplate. The waveplate 107 is provided on an optical path between the collimator lens 105 and the objective lens 108, and has a light blocking section, at a central area thereof, for blocking a central portion of the laser beam in a substantially circular shape. The light blocking section will be described later in detail.

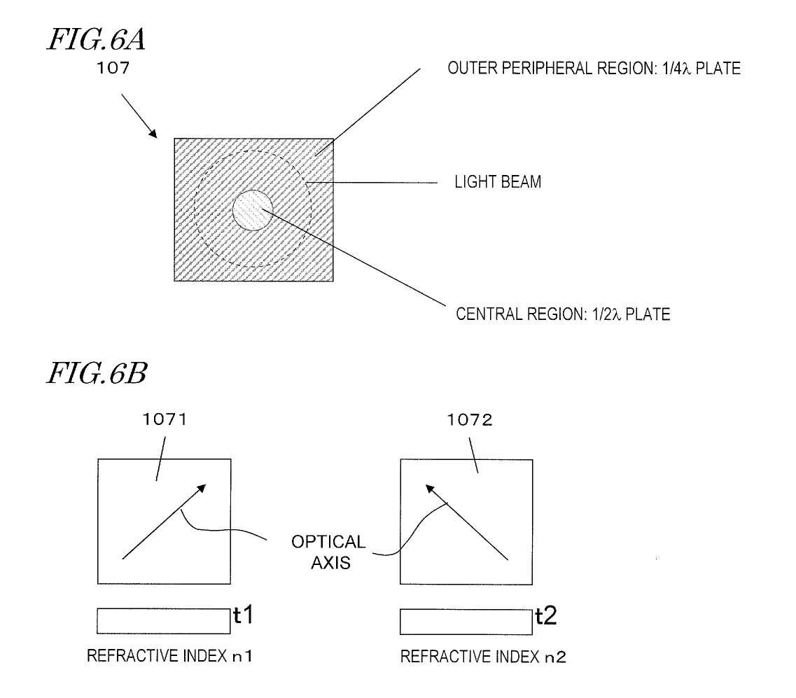

More specifically, as shown in FIG. 6A, of an area of the waveplate 107 which is passed by the laser beam, a central circular area acts as a ½λ waveplate for the semiconductor laser 101 for BD and the semiconductor laser 102 for DVD. Still as shown in FIG. 6A, of the area of the waveplate 107 which is passed by the laser beam, an area other than the central circular area acts as a ¼λ waveplate for the semiconductor laser 101 for BD and the semiconductor laser 102 for DVD.

The above-described structure of the waveplate 107 can be realized by the following method. The following example regards a structure of the ¼λ plate for the semiconductor laser 101 for BD and the semiconductor laser 102 for DVD. The waveplate 107 acting as a ¼λ plate for the semiconductor laser 101 for BD and the semiconductor laser 102 for DVD can be obtained by bringing two quarts plates together. FIG. 6B shows a first quartz plate 1071 and a second quartz plate 1072, which are the two quarts plates.

The first quartz plate 1071 and the second quartz plate 1072 are brought together such that optical axes thereof are perpendicular to each other, namely, such that the fast axis and the slow axis match each other.

Here, it is assumed that the thickness of the first quartz plate is t1 and the thickness of the second quartz plate is t2. When t1=t2, the total phase shift is 0. By contrast, t1≠t2, the thickness difference (t1−t2) is the phase shift.

Now, a structure of the ¼λ plate when the wavelength λ is 500 nm will be discussed.

The first quartz plate 1071 has an optical axis directed to upper right at an angle of 45 degrees and the thickness t1 thereof is 0.3135 mm. The second quartz plate 1072 has an optical axis directed to upper left at an angle of 45 degrees and the thickness t2 thereof is 0.3 mm. In this state, the following expression is fulfilled.

t1−t2=Δ(n1−n2)

*1: Δ=¼λ=0.125 μm

*2: n1−n2=0.00925 (refractive index of quartz when λ=500 nm)

In this manner, the ¼λ plate can be realized. The ½λ plate for the semiconductor laser 101 for BD and the semiconductor laser 102 for DVD can be realized in a similar manner.

The objective lens 108 is a light collecting lens for the semiconductor laser 101 for BD and the semiconductor laser 102 for DVD. The objective lens 108 is structured such that the NA thereof for the semiconductor laser 101 for BD is 0.85 and the NA thereof for the semiconductor laser 101 for BD is 0.65. The objective lens 108 is driven by the actuator 112. The actuator 112 drives the objective lens 108 to realize focus control and tracking control on the optical disc.

The hologram 109 is a diffraction grating. The hologram 109 diffracts a part of light. The light diffracted by the hologram 109 is incident on light receiving sections 1112, 1113, 1114 and 1115 of the light detector 111 and is used as a sub signal (correcting signal) for a tracking error signal.

The cylindrical lens 110 is a lens having a cylindrical face and a planar lens.

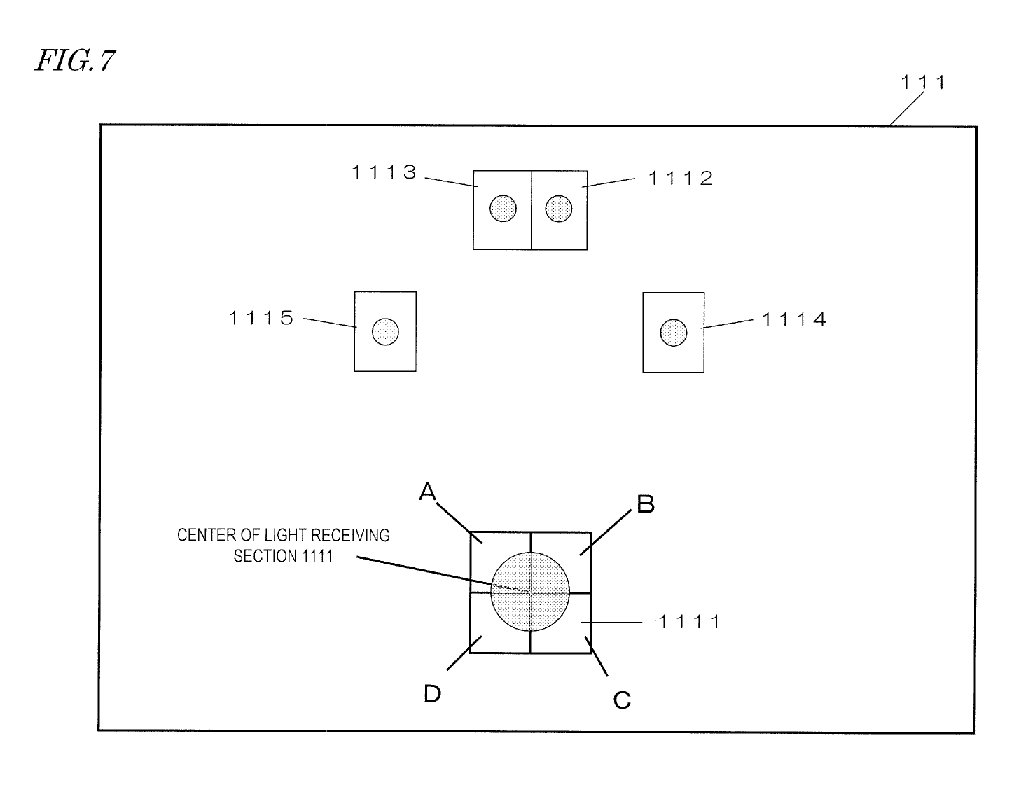

The light detector 111 detects the laser beam reflected by the BD 200 (DVD 300). FIG. 7 shows a structure of the light detector 111. The light detector 111 includes light receiving sections 1111, 1112, 1113, 1114 and 1115 (FIG. 7).

The light receiving section 1111 is located such that the light transmitted through the hologram 109 and collected by the cylindrical lens 110 is incident thereon. The light receiving section 1111 includes four areas A through D. The four areas are formed of a photodiode for converting the received light into an electric signal. The signal detected by the light receiving section 1111 is input to the control section 90 of the drive 10.

Thus, the control section 90 of the drive 10 generates a focus error signal (FE signal), a main signal of tracking error (TE main signal), an RF signal and the like based on the light obtained by the light receiving section 1111. Such signals can be found by the following expressions.

FE signal=(A+C)−(B+D)

TE main signal=(A+B)−(C+D)

RF signal=A+B+C+D

### <3. Size of the Central Area of the Waveplate 107>

Now, the size of the central area of the waveplate 107 is defined. The size of the central portion of the waveplate 107 needs to be defined in consideration of the RF signal. A reason for this is that where the size of the central area of the waveplate 107 is too large, there is a risk that the RF signal component is lost and so the quality of the signal is deteriorated.

Therefore, in this embodiment, a structure for blocking the laser beam from the semiconductor laser 102 for DVD which has a smaller radius than the laser beam from the semiconductor laser 101 for BD will be considered. Where the size of the light blocking area is set to a level at which a certain level of quality of the RF signal for the DVD light beam is guaranteed, the ratio of the blocked portion of the BD light beam with respect to the entirety thereof is necessarily smaller than that of the DVD light beam because the radius of the BD light beam is larger than that of the DVD light beam in terms of the NA ratio. For this reason, setting the size of the light blocking area to a level at which a certain level of quality of the RF signal for the DVD is guaranteed also guarantees a certain level of quality of the RF signal for the BD.

In order to provide a structure, where the radius of the laser beam from the semiconductor laser 102 for DVD is φ, the size of the central area of the waveplate 107 is designed such that the radius φm of the central area to be blocked fulfills the condition of φm/φ<0.3. When the above condition is fulfilled, the problems caused by the light blocking that the reproduction signal is distorted by the loss of the RF signal component, jitter is deteriorated and the like can be suppressed.

As a result of an optical simulation, the optical jitter when the light was not blocked was 2.8%, whereas the optical jitter when the ratio of the blocked light (φm/φ) was 30% was 4.7% and the optical jitter when the ratio of the blocked light was 40% was 6.5%. Reproduction jitter, which is one of main indices of the quality of a reproduction signal is determined by a combination of various factors including circuit noise, laser noise, disc noise and the like in addition to the optical jitter. Therefore, in an area in which the absolute value of the optical jitter is small, even where the jitter value is increased slightly, such an increase does not have a conspicuous influence because of being obscured by the other jitter factors. However, in general, where a single factor of the optical jitter exceeds 5%, this has a conspicuous influence on the entire reproduction jitter. Therefore, it is preferable that the optical jitter is suppressed to 5% or less.

Henceforth, when the ratio of the blocked light (φm/φ) is set to 0.3 or less, the central portion of the light beam can be blocked while the performance of the waveplate 107 for practical use can be guaranteed.

### <4. Optical Path in the Optical Pickup Device>

A path of the light emitted from each of the semiconductor laser 101 for BD and the semiconductor laser 102 for DVD in the optical pickup device 100 will be described with reference to FIG. 5.

<4.1 Path of Light from the Semiconductor Laser 101 for BD>

From the semiconductor laser 101 for BD, a laser beam is emitted. The laser beam emitted from the semiconductor laser 101 for BD is incident on the cubic beam splitter 104 as S polarization. The cubic beam splitter 104 reflects the laser beam as the S polarization. The laser beam reflected by the cubic beam splitter 104 is converted into collimated light by the collimator lens 105. The laser beam converted into the collimated light by the collimator lens 105 is incident on the reflector plate 106. The reflector plate 106 reflects the incident laser beam. The laser beam reflected by the reflector plate 106 is transmitted through the waveplate 107. By the waveplate 107, the incident laser beam is caused to have a ½λ phase shift in the central portion thereof and a ¼λ phase shift in an outer peripheral portion thereof. The laser beam having such phase shifts is collected by the objective lens 108. The light collected by the objective lens 108 is reflected by the BD 200.

Next, the laser beam reflected by the BD 200 is transmitted through the objective lens 108 to be converted into collimated light. The laser beam converted into the collimated light by the objective lens 108 is transmitted through the waveplate 107. By the waveplate 107, the incident laser beam is further caused to have a ½λ phase shift in the central portion thereof and a ¼λ phase shift in the outer peripheral portion thereof. Namely, as a result of being transmitted through the waveplate 107 in a forward run and a return run, the central portion of the laser beam is caused to have a λ phase shift and the outer peripheral portion of the laser beam is caused to have a ½λ phase shift.

The laser beam transmitted through the waveplate 107 is transmitted through the reflector plate 106 and is incident on the cubic beam splitter 104. The cubic beam splitter 104 has a structure for transmitting P polarization but not for transmitting S polarization of the light from the collimator lens 105 and the semiconductor laser 101 for BD. Therefore, the central portion of the laser beam, which is the S polarization, is reflected and the outer peripheral portion of the laser beam, which is the P polarization, is transmitted.

As a result, the outer peripheral portion of the laser beam transmitted through the cubic beam splitter 104 is incident on the plate beam splitter 103. The plate beam splitter 103 has a structure for transmitting all the light of the BD wavelength regardless of the type of polarization. The laser beam transmitted through the plate beam splitter 103 is transmitted through the hologram 109 and the cylindrical lens 110 and is incident on the light detector 111.

By such a structure, of the light emitted from the semiconductor laser 101 for BD, the central portion of the light is suppressed from being incident on the light detector 111.

<4.2 Path of Light from the Semiconductor Laser 102 for DVD>

From the semiconductor laser 102 for DVD, a laser beam is emitted. The laser beam emitted from the semiconductor laser 102 for DVD is incident on the plate beam splitter 103 as S polarization. The plate beam splitter 103 reflects the laser beam as the S polarization. The laser beam reflected by the plate beam splitter 103 is transmitted through the cubic beam splitter 104 and is converted into collimated light by the collimator lens 105. The laser beam converted into the collimated light by the collimator lens 105 is incident on the reflector plate 106. The reflector plate 106 reflects the incident laser beam. The laser beam reflected by the reflector plate 106 is transmitted through the waveplate 107. By the waveplate 107, the incident laser beam is caused to have a ½λ phase shift in the central portion thereof and a ¼λ phase shift in an outer peripheral portion thereof. The laser beam having such phase shifts is collected by the objective lens 108. The light collected by the objective lens 108 is reflected by the DVD 300.

Next, the laser beam reflected by the DVD 300 is transmitted through the objective lens 108 to be converted into collimated light. The laser beam converted into the collimated light by the objective lens 108 is transmitted through the waveplate 107. By the waveplate 107, the incident laser beam is further caused to have a ½λ phase shift in the central portion thereof and a ¼λ phase shift in the outer peripheral portion thereof. Namely, as a result of being transmitted through the waveplate 107 in a forward run and a return run, the central portion of the laser beam is caused to have a λ phase shift and the outer peripheral portion of the laser beam is caused to have a ½λ phase shift.

The laser beam transmitted through the waveplate 107 is transmitted through the reflector plate 106 and is incident on the cubic beam splitter 104. The cubic beam splitter 104 has a structure for transmitting all the light of the DVD wavelength regardless of the type of polarization.

Of the light incident on the plate beam splitter 103, the central portion, which is the S polarization, is reflected, and the outer peripheral portion, which is the P polarization, is transmitted.

The laser beam transmitted through the plate beam splitter 103 is transmitted through the hologram 109 and the cylindrical lens 110 and is incident on the light detector 111.

By such a structure, of the light emitted from the semiconductor laser 102 for DVD, the central portion of the light is suppressed from being incident on the light detector 111.

An embodiment of the present invention has been described, but the present invention is not limited to this. Other embodiments (modifications) of the present invention will be described, hereinafter. The present invention is not limited to the following embodiments and is applicable to embodiments appropriately modified by a person of ordinary skill in the art.

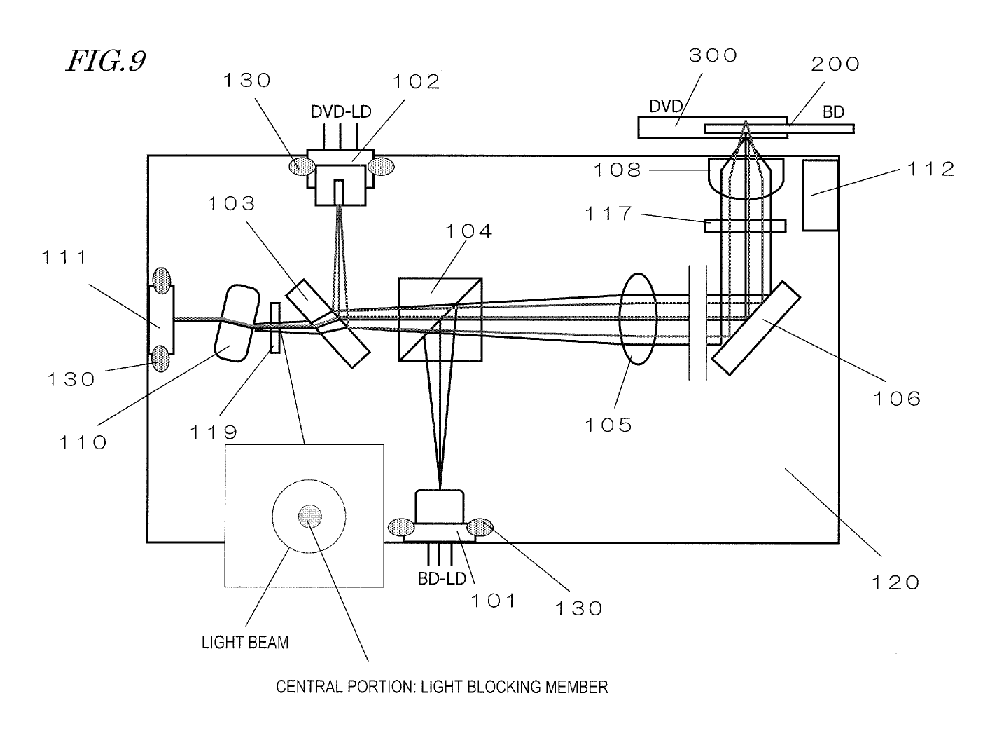

In the above embodiment, the central portion of the laser beam is blocked by the waveplate 107 and the cubic beam splitter 104. However, the present invention is not limited to this, and the light may be blocked by a method shown in FIG. 9.

Unlike the structure in FIG. 5, the structure in FIG. 9 includes a ¼λ plate 117 instead of the waveplate 107 and includes a hologram (for blocking the central portion of light) 119 instead of the hologram 109. The structures of the ¼λ plate 117 and the hologram (for blocking the central portion of light) 119 will be described.

The ¼λ plate 117 is a member acting as a ¼λ waveplate for the laser beam from the semiconductor laser 101 for BD or the semiconductor laser 102 for DVD.

The hologram (for blocking the central portion of light) 119 is a member for blocking the central portion of the laser beam emitted from the semiconductor laser 101 for BD or the semiconductor laser 102 for DVD and reflected by the optical disc. The hologram (for blocking the central portion of light) 119 is obtained by applying a light blocking paint on a central area of a hologram. The light blocking means is not limited to the above-mentioned form and may be in the form of a reflective film, an absorptive film, a diffracting grating or the like, or may be formed of other materials.

Owing to such a structure, the central portion of the laser beam emitted from the semiconductor laser 101 for BD or the semiconductor laser 102 for DVD can be suppressed from being incident on the light detector 111.

The optical pickup devices 100 according to embodiments of the present invention have been described. The optical pickup device 100 includes the optical base 120, the semiconductor laser 101 for BD, fixed to the optical base 120, for emitting a laser beam, the objective lens 108 for collecting the laser beam onto the optical disc 200, the light detector 111, fixed to the optical base 120, for detecting the laser beam reflected by the optical disc 200, an adhesive for fixing the semiconductor laser 101 for BD and the light detector 111 onto the optical base, and the waveplate 107 and the cubic beam splitter 104 for blocking the central portion of the laser beam in a circular shape on the optical path from the semiconductor laser 101 for BD to the light detector 111.

Owing to such a structure, the light detector 111 can detect the portion of the laser beam other than the central portion thereof. Therefore, the optical pickup device 100, owing to the light detector 111, can suppress the quality of a signal necessary for tracking control or focus control, especially the sensitivity to the shift of a relative position of the light source or the light detector, from being deteriorated. Namely, highly reliable detection of a control signal is made possible.

Thus, the optical pickup device can improve the reliability of tracking control or focus control.

The hologram (for blocking the central portion of light) 119 blocks only the laser beam reflected by the optical disc 200.

Owing to this, the laser beam reaching the objective lens 108 from the semiconductor 101 for BD is not acted on at all. Therefore, the deterioration in the light collecting performance of the objective lens can be alleviated.

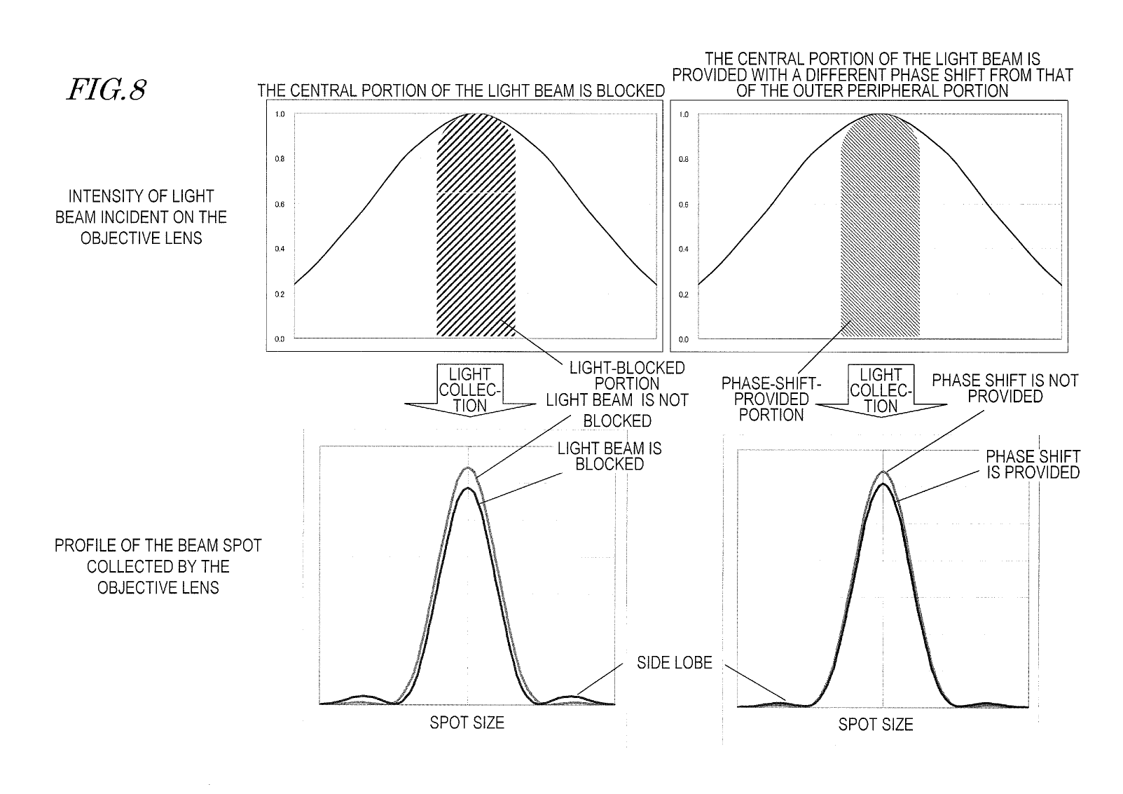

When a portion of the laser beam is caused to be have a phase shift between the light source and the objective lens or when the laser beam is partially blocked, there is a problem that the light collecting performance is deteriorated. As shown in FIG. 8, when the central portion of the light incident on the objective lens is blocked, as compared with when the light is not blocked, the phenomenon occurs that the intensity of the central portion of the optical spot is lowered and the intensity of the side lobe is raised. This increases the influence of the inter-code interference with a previous or subsequent signal or the crosstalk with a left or right track, which lowers the signal quality.

FIG. 8 also shows a spot of collected light when the central portion of the light is caused to have a phase shift different from that of the outer peripheral portion, instead of being blocked. In this case also, although the influence is alleviated as compared with when the central portion of the light is blocked, it can be seen that the intensity of the central portion of the light is lowered and the intensity of the side lobe is raised.

However, with a structure in which neither the light blocking nor the phase has influence on the light on the optical path between the light source and the objective lens and the central portion of only the light beam incident on the light detector is blocked, the above-mentioned problems can be overcome.

Namely, in the structure in this embodiment, it is optimum to provide a light blocking member between the light detector lens and the light detector.

The waveplate 107 and the cubic beam splitter 104 block the laser beam such that, where the radius of the laser beam at a certain position is φ, the radius of the light to be blocked at that position fulfills the condition of φm/φ<0.3.

Such an arrangement can suppress the loss of the signal component (RF signal) for reading information recorded on an optical disc and also can suppress the quality of a signal necessary for tracking control or focus control, especially the sensitivity to the shift of a relative position of the light source or the light detector, from being deteriorated. Namely, highly reliable detection of a control signal is made possible.

The optical pickup device 100 includes the semiconductor laser 102 for DVD in addition to the semiconductor laser 101 for BD. The semiconductor laser 102 for DVD emits a laser beam having a longer wavelength than the semiconductor laser 101 for BD, and the objective lens 108 is structured to collect the laser beam from the semiconductor laser 101 for BD or the semiconductor laser 102 for DVD. The waveplate 107 and the cubic beam splitter 104 blocks the laser beam from the semiconductor laser 102 for DVD such that, where the radius of the laser beam at a certain position is φ, the radius of the light to be blocked at that position fulfills the condition of φm/φ<0.3.

The radius of the BD light beam is larger than that of the DVD light beam in terms of the NA ratio. Therefore, the ratio of the portion of the BD light beam to be blocked with respect to the entirety thereof is necessarily smaller than the ratio in the case of the DVD. Therefore, where the size of the light blocking area is set to a level at which a certain level of quality of the RF signal for the DVD light beam is guaranteed, a certain level of quality of the RF signal for the BD light beam can also be guaranteed.

In this manner, a certain level of quality of the RF signals for both of the DVD and the BD can be guaranteed and also the reliability of the control signal can be improved.

Finally, experimental results regarding the effect of improving the reliability of the control signal provided by blocking the central portion of the beam to be detected will be shown.

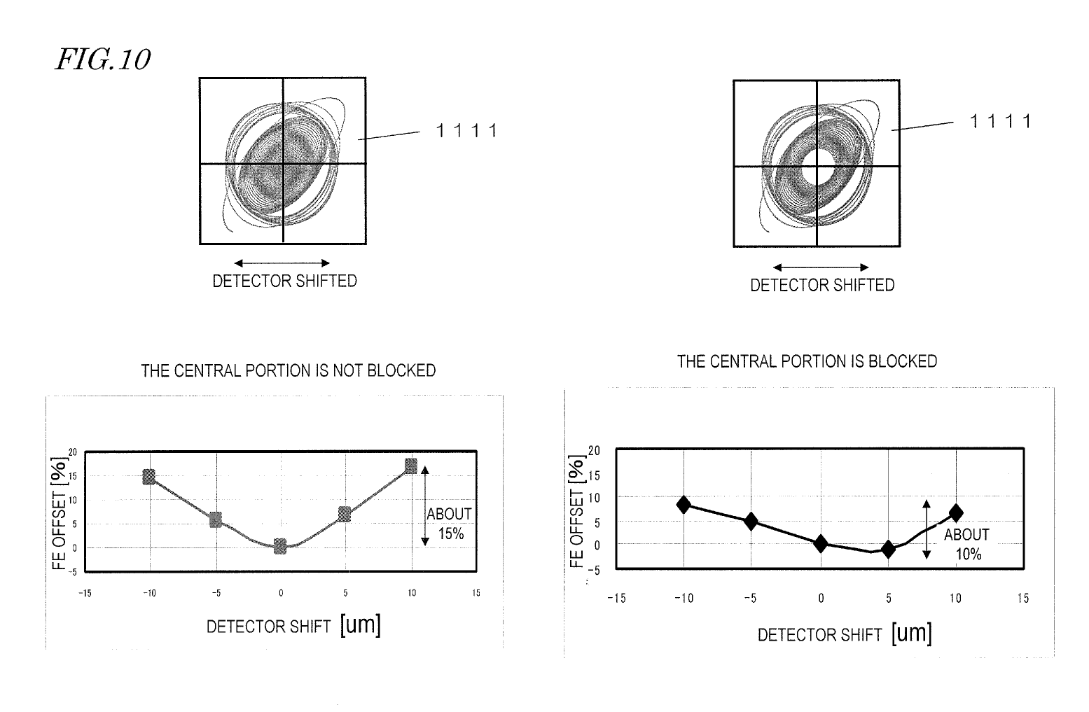

FIG. 10 shows measurement results of an FE offset amount when the central portion of the beam to be detected is blocked by 30% in terms of the ratio of the radius of the light beam.

Where the central portion is not blocked, when the relative positions of the detector and the beam to be detected are shifted by 10 μm, an FE offset amount of about 15% is caused. By contrast, where the central portion of the beam is blocked by 30%, the FE offset is suppressed to about 10%. It is understood that the sensitivity of the FE offset to the shift of the relative positions of the detector and the beam to be detected is reduced by 30% as compared with the light is not blocked. In this case, no other form of deterioration was found in the FE signal quality including the S-shaped waveform or the leak of the groove-crossing signal.

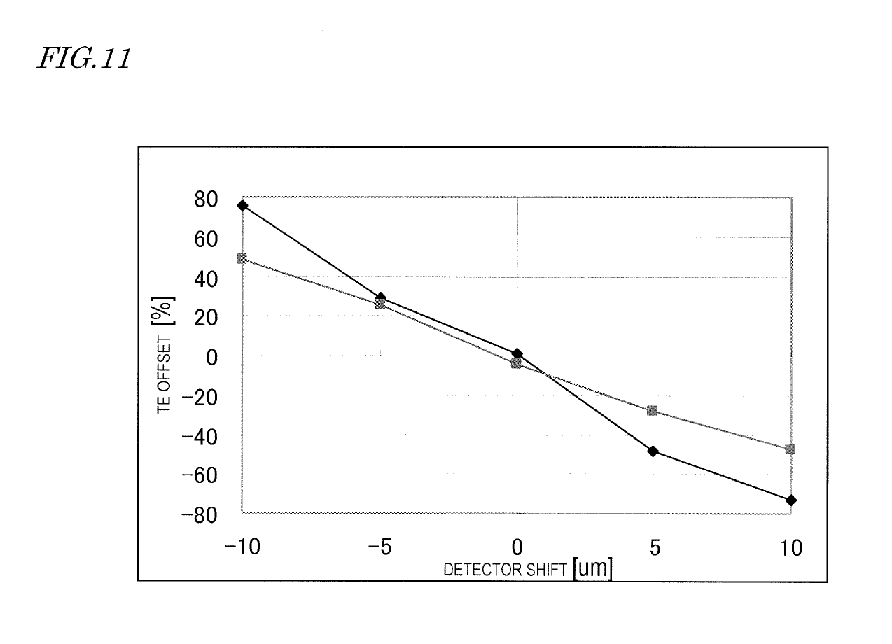

FIG. 11 shows measurement results of a TE offset amount of a TE main signal under similar conditions. With these results also, the sensitivity of the TE offset to the shift of the relative positions of the detector and the beam to be detected is reduced by 30% as compared with where the light is not blocked. In this case also, no other harm was found to the TE signal quality regarding the amplitude of the TE signal or the like. Regarding the reproduction jitter, which is an index of the RF signal quality, a range of practically usable values was obtained.

From the above results, it is considered that where the central portion of the beam to be detected is blocked by 30% in terms of the ratio of the radius of the light beam, the reliability of a control signal against the shift of the relative positions of the light detector and the beam to be detected can be improved by about 30% while the quality of the servo signal and the RF signal is maintained in a range of practically usable values.

The present invention can be realized as an optical pickup device usable for a player, a recorder and the like. The present invention can also be realized as an optical disc drive of a player, a recorder and the like having such an optical pickup device mounted thereon.

What is claimed is:

1. An optical pickup device, comprising:
a base member;
at least one light source, fixed to the base member, for emitting a light beam;
a collimator lens for converting the light beam emitted from the at least one light source into a substantially parallel light beam;
an objective lens for collecting the light beam converted into the substantially parallel light beam onto an optical disc;
a light detector, fixed to the base member, for receiving the light beam reflected by the optical disc via the collimator lens; and
a light blocking section for blocking a central portion of the light beam in a substantially circular shape on an optical path between the collimator lens and the objective lens.

2. The optical pickup device of claim 1, wherein the light blocking section blocks the light beam reflected by the optical disc.

3. The optical pickup device of claim 1, wherein the light blocking section blocks the light beam such that, where the radius of a laser beam at a certain position is φ, the radius φm of light beam to be blocked at the certain position fulfills the condition of φm/φ<0.3.

4. The optical pickup device of claim 2, wherein the light blocking section blocks the light beam such that, where the radius of a laser beam at a certain position is φ, the radius φm of light beam to be blocked at the certain position fulfills the condition of φm/φ<0.3.

5. The optical pickup device of claim 1, wherein:
the at least one light source includes a first light source and a second light source;
the second light source emits a light beam having a longer wavelength than the first light source;
the objective lens respectively collects the light beams from the first light source and the second light source onto the optical disc; and
the light blocking section blocks the light beam from the second light source such that, where the radius of the light beam from the second light source at a certain position is φ, the radius φm of light beam to be blocked at the certain position fulfills the condition of φm/φ<0.3.

6. The optical pickup device of claim 2, wherein:
the at least one light source includes a first light source and a second light source;
the second light source emits a light beam having a longer wavelength than the first light source;
the objective lens collects the light beams from the first light source and the second light source onto the optical disc; and
the light blocking section blocks the light beam from the second light source such that, where the radius of the light from the second light source at a certain position is φ, the radius φm of light beam to be blocked at the certain position fulfills the condition of φm/φ<0.3.

7. An optical disc drive, comprising:
an optical pickup device;
a transport motor for moving the optical pickup;
a spindle motor for rotating an optical disc;
a driving circuit for driving the transport motor and the spindle motor; and
a control section for instructing amount of the transport motor and the spindle motor to the driving circuit;
wherein the optical pickup device includes:
a base member;
at least one light source, fixed to the base member, for emitting a light beam;
a collimator lens for converting the light beam emitted from the at least one light source into a substantially parallel light beam;
an objective lens for collecting the light beam converted into the substantially parallel light beam on the optical disc;
a light detector, fixed to the base member, for receiving the light beam reflected by the optical disc via the collimator lens; and
a light blocking section for blocking a central portion of the light beam in a substantially circular shape on an optical path between the collimator lens and the objective lens.
